(19) United States
(12) Patent Application Publication
(10) Pub. No.: US 2003/0150501 A1
(43) Pub. Date: Aug. 14, 2003

(54) Thermoplastic pipeline-liner not requiring venting of the annulus between the liner and the host pipe

(75) Inventor: James F. Mason, Birdsboro, PA (US)

Correspondence Address: ATOFINA CHEMICALS INC., PATENT DEPARTMENT - 26TH FLOOR, 2000 MARKET STREET, PHILADELPHIA, PA, 19103-3222, US

(73) Assignee: ATOFINA Chemicals, Inc.

(21) Appl. No.: 10/337,715

(22) Filed: Jan. 7, 2003

Related U.S. Application Data
(63) Continuation-in-part of application No. 10/048,313, filed on Jan. 29, 2002.

(51) Int. Cl. F16L 9/18; B32B 1/08

(52) U.S. Cl. 138/114; 428/36.91; 138/148

(57) ABSTRACT

Improved thermoplastic liner containing metal pipelines in which the liners consist essentially of polyamide 11 or polyamide 12 as well as methods for their preparation and use are disclosed.

This application is a continuation-in-part of copending application Ser. No. 10/048,313 filed Jan. 29, 2002, which application in turn claims priority from provisional application 60/213,942, filed Jun. 23, 2000.

### BACKGROUND OF THE INVENTION

This invention relates to articles of manufacture in the art of volatile and potentially chemically corrosive fluid transport, compositions of matter classified in the art of chemistry as polyamides, particularly polyamides 11 and 12 as well as processes for the manufacture and use of said articles of manufacture and said compositions of matter.

Pipelines in oil fields where the petroleum products recovered from production wells contain corrosive non hydrocarbon contaminants must either be constructed from materials resistant to corrosion such as corrosion resistant alloys including stainless steel, duplex and super-duplex steels which are expensive, flexible pipes with thermoplastic liners which are also expensive and require the presence of an inner flexible steel pipe to prevent the presence of an inner flexible steel pipe to prevent liner collapse and continuous venting of the annular space behind the thermoplastic liner, or corrosion inhibition chemicals must be continuously injected into the stream being carried through an ordinary carbon steel expedient is only partially effective because corrosion is only reduced not eliminated, and unexpected failure at a weak point is always a concern. All of these techniques involve considerable expense either for the initial cost of the corrosion resistant materials or for the continuing cost of the anti-corrosion chemicals. In addition, corrosion inhibited lines need periodic interruption of flow and internal inspection by special devices (“smart pigs”) which measure thickness of the steel pipe and allow estimation of the corrosion rate. A far less expensive overall solution has been the use of thermoplastic, usually, until now, high or medium density polyethylene, lined carbon steel pipes.

This solution has the advantage of relatively low initial cost and good protection of the steel from the corrosive ingredients in the flow of stream through the pipeline. Such lined pipelines in oil field transport service or even in other services where gaseous materials are being transported under pressure are normally required to be fitted with a vent near the end of each line pipe segment to permit venting of gases which accumulate in the annular space (annulus) between the thermoplastic liner and the metal pipe. The vent is normally located within a short distance of each coupling of each segment of the pipeline. A segment is normally terminated by flanges or other mechanical coupling at each end in a manner that separates the annular space of one segment from the annular space of the adjacent segment(s). The gases accumulating in each annulus are periodically vented based on policies and/or regulations intended to avoid excessive pressure on the thermoplastic liners which prior experience has shown invariably were prone to irreversible collapse when pressure in the annulus became great enough to exceed the capacity of the thermoplastic liner and periodic operation of the vents was not possible for any reason, the use of thermoplastic liners has always been considered to be not feasible for the above reason.

The consequence of collapse is, of course, interruption (or at least reduction) of flow of material through the pipeline and, with thermoplastic materials presently used, possible rupture of the liner or at the least a permanent deformation which makes resumption of full flow through the collapsed portion not possible. In the event of collapse, therefore, the damaged liner section must be removed and replaced. This is a costly process even if the lost revenue from down time of the pipeline on which replacement is being performed is not considered.

The present invention provides thermoplastic liners for pipelines which are immune or highly resistant to permanent damage from the deformation resulting from collapse and which are sufficiently resilient to recover their precollapse shape and dimensions once the over pressure in the annulus has been removed.

### SUMMARY OF INVENTION

The invention provides in a first composition aspect an improved thermoplastic polymer lined metal pipeline for the transport of petroleum products wherein the improvement comprises the thermoplastic liner in said lined pipeline consisting essentially of polyamide 11 or polyamide 12 and which has the ability to resist permanent collapse and recover completely from multiple transient collapses, thus, permitting the space between the metal pipeline and the thermoplastic liner to be unvented for extended periods of time beyond what is normally done for conventional thermoplastic liners.

The tangible embodiments of the first composition aspect of the invention possess the inherent applied use characteristic of being able to transport petroleum products over long distances without requiring frequent vent points or even completely without vents such as use in subsea pipelines and pipelines located in remote and inaccessible locations where regular venting is difficult or impossible, thereby insuring better pipeline integrity than is possible with the use of corrosion inhibition chemicals alone and permitting use of low cost carbon steel for such service rather than requiring high cost special allows or flexible pipes.

Special mention is made of composition aspects of the invention wherein the thermoplastic liner is polyamide 11 or polyamide 12 and the annulus between the outside diameter of the thermoplastic liner and the inside diameter of the metal pipe ranges from 0% to about 5%, preferably from about 0% to about 3% of the theoretical space available between the liner and the pipe at 100% theoretical elongation of the liner (loose fit liner).

The invention also provides in a process aspect, an improved process for lining a metal pipeline with a thermoplastic liner, said liner having the ability to recover from multiple transient collapses and wherein said ability to recover from multiple transient collapses is desired, wherein the improvement comprises inserting a thermoplastic liner consisting essentially of polyamide 11 or polyamide 12 in said metal pipeline in a loose fit configuration.

As used herein and in the appended claims, “petroleum products” means crude natural gas, crude oil as produced, mixtures of crude oil and natural gas including any non-hydrocarbon contaminants thereof as well as refined products derived from crude oil and natural gas.

### DETAILED DESCRIPTION

The best mode of practicing the invention will now be described with respect to use of polyamide 11, the polymer prepared by condensation of 11-amino undecylenic acid, although one of skill in the art will recognize that polyamide 12, the polymer prepared by condensation of the lactam of 12-aminododecylenic acid, for which equivalent fabrication and applicable related handling techniques are also well understood by those of skill in the art, will be contemplated as equivalent by the invention.

There are three important features for the successful practice of the invention, the correct liner material, the correct liner dimensions relative to those of the host pipe and the correct stress state of the liner after installation in the host pipe.

To prepare a pipeline of the invention a plasticized polyamide 11 may be extruded as a liner shape having an outside diameter that is the same as or slightly less than the inside diameter of the host pipe. The extrusion may be cut to any length convenient for handling and transport to the installation location. Suitable plasticizers for polyamide 11 (and polyamide 12) are well known in the art. Preferred is N,n-butyl benzene sulfonamide. Long chain diols, sulfonamides and other highly polar compounds are known to generally provide plasticization in polyamides in general. A chemist will readily recognize which compounds in the above classes are suitable and unsuitable.

A typical range for the outside diameter of the liner is from zero to five percent smaller than the inside diameter of the host pipe.

Installation of the liner into the length of host pipe on site may be by any known conventional technique. A convenient method is by pulling with a cable from the distant end of the pipeline to be lined.

To form long, continuous lengths of liner for the insertion in the interior of the pipeline, the liner segments cut into transport lengths must be welded at the joints to form a continuous length of liner. This is accomplished by standard fusion welding techniques well known in the art. The joints have sufficient strength to withstand the tensile stress of the insertion process without breaking and the liner material also has sufficient tensile strength to withstand pulling through the steel host pipe without sustaining permanent dimension changes while under tensile stress for the duration of the insertion process which may be from several minutes to several hours depending on the length of the pipeline to be lined. After being pulled through the host pipe, the liner material may be stretched up to about 10% in length so that appropriate termination fitting may be fused onto the ends. This is to compensate for the differential thermal expansion between a steel pipe and the thermoplastic liner upon going from installation temperature to operating temperatures. The stretch must be calculated for each case, using known methods, to avoid over or under stretching. The liner must then undergo a radial expansion of from about zero to about 5 percent by pneumatic or hydraulic internal pressure for long periods of time in the operating environment without losing its ability to recover substantially to the original radial dimensions upon reduction of the internal pressure.

Plasticized polyamide 11 and polyamide 12 both possess the required properties.

Without being bound to any particular theory, it is believed that these materials work because relaxation (retraction from the host pipe wall) provides a space into which high pressure annular gases (which diffuse through the liner) can expand. This reduces the pressure in the annulus, thereby resulting in smaller radial compressive stresses which are the cause of most liner collapse. The relaxation away from the wall happens because the liner was inserted loose and expanded and did not undergo a stress relaxation or swelling as polyethylene based liners do. The improved liner materials of the invention retain their elastic properties during its lifetime and are able to recover from collapse when the pressure differential is reversed.

By way of contrast, the substantial majority of all installed liners in oil field service are made from either high density polyethylene or medium density polyethylene. They are installed by several different methods which can be summarized by the stress state in which they leave the liner. Liners inserted by diameter reduction are left in a state of radial compression and axial tension. Liners inserted by diameter expansion are left in a state of radial tension and axial compression. For the polyethylene (PE) materials these are transient stress states. Under the influence of temperature and time, the materials stress-relax to an essentially neutral stress state. If hydrocarbons are present, the PE materials will absorb large quantities over time. Eventually over a time period longer than that required for the original stress relaxation, this reduces the stiffness of the polymer and causes simultaneous swelling in the radial and axial directions. This swelling causes its own stresses. Stresses alone are sometimes sufficient to cause collapse of the liner due to the dramatically reduced stiffness of the liner when compared to its initial state.

Proper design techniques are known which can normally avoid this result but the liner is still left in a state where it has lost its elastic properties and changes in pressure internally can cause collapse. When a stress relaxed, hydrocarbon swollen liner collapses, it undergoes a mechanical yield, and in some cases the deformation is sufficient to cause the liner to break, a PE liner inserted by diameter expansion will never, after the initial stress relaxation, be able to retract from the wall of the steel host pipe in response to a reduction in the internal pressure. PE liners inserted by diameter reduction were never able to move from the host pipe wall from the time of their insertion and this situation is not improved with age.

The following comparative tests further illustrate the best mode contemplated by the inventor for the practice of his invention.

Tests were conducted to observe the behavior of polyamide 11 and HDPE liners when subjected to conditions intended to result in collapse of the liner. The tests were done using representative steel pipeline segments with a length of 10 feet and made from nominal 4 inch steel pipe. The wall thickness of the steel pipe was chosen such that the 4.0 inch diameter liner, after insertion, would be either loose (liner OD<steel ID), neutral (liner OD=steel ID), or tight (liner OD>steel ID). Table 1 shows the room temperature and test temperature dimensions as well as the calculated liner tightness. Negative tightness indicates a loose liner.

TABLE 1
Liner tightness for the materials and operating conditions of this study.

| | | Steel ID | Liner | Steel ID | Liner | Steel ID | Liner |
|---|---|---|---|---|---|---|---|
| Temperature | Liner OD | Loose | Tightness | Neutral | Tightness | Tight | Tightness |
| Rilsan | | | | | | | |
| 23 | 4.000 | 4.1240 | −3.1% | 4.0000 | 0.0% | 3.8760 | 3.01% |
| 80 | 4.010 | 4.1247 | −2.8% | 4.0007 | 0.2% | 3.8767 | 3.4% |
| 90 | 4.014 | 4.1248 | −2.7% | 4.0008 | 0.3% | 3.8768 | 3.5% |
| 105 | 4.020 | 4.1249 | −2.5% | 4.0009 | 0.5% | 3.8769 | 3.7% |
| HDPE | | | | | | | |
| 23 | 3.900 | 4.1240 | −5.4% | 4.0000 | −2.5% | 3.8760 | 0.6% |
| 40 | 3.902 | 4.1242 | −5.4% | 4.0002 | −2.5% | 3.8762 | 0.7% |
| 60 | 3.904 | 4.1244 | −5.3% | 4.0004 | −2.4% | 3.8764 | 0.7% |

The liners were inserted into the steel test pipes by conventional means and terminated at each end by flaring the thermoplastic liner to conform to the existing flange fitting on the steel pipe. A blind flange was attached, compressing the liner against the steel termination flange, isolating the annulus from the pipe bore.

The test pipes were provided with a threaded injection port located approximately 36 inches from one end. This port was fitted with an injection apparatus and an independent valve to isolate the injection apparatus from the pipe. It was also fitted with an independent valve connecting the injection port to the collection apparatus. There were other threaded ports located along the pipe for the purpose of recovering liquids from the annulus during the experiment. These ports were fitted with independent valves and attached to the collection apparatus consisting of suitable tubing to deliver the oil to graduated cylinders for the purpose of measuring the volume of oil ejected from the annulus.

The lined pipes were filled with a fluid mixture that simulates typical crude oil and gas service. The composition is shown in Table 2. The temperature was raised through the use of external heating jackets to 500 psi. The pipes were gently rocked to agitate the internal pipeline contents. This condition was maintained for 6 weeks to condition the liners for the collapse experiments to follow.

To make the collapse experiments oil was injected into the annulus through the injection port using a precision piston pump and appropriate steel pressure fittings and tubing. The volume of oil injected was monitored by noting the piston position indicator. The pressure in the annulus was measured by a pressure gauge fitted at the injection port.

TABLE 2
Composition of test fluid

| Fluid Phase | Volume Percent | Species | Percent |
|---|---|---|---|
| Liquid | 80 | Crude Oil | 95 volume percent |
| | | Produced Water | 5 volume percent |
| | | Methane | 80 mole percent |
| Gas | 20 | Hydrogen sulfide | 15 mole percent |
| | | Carbon dioxide | 5 mole percent |

Before beginning the collapse experiments the graduate cylinders were filled to the upper mark with oil. The total volume of oil was calculated to be much larger than the theoretical annulus of the depressurized liner. The tubes from the collection system were immersed into the graduated cylinders and the amount of oil was adjusted to make oil volume up to the upper mark. The collection system valves were opened. Then the pipe bore pressure was reduced to ambient pressure (approximately 1 atm.) and left open to the atmosphere. Oil was drawn into the annulus if the liner moved away from the steel pipe wall on depressurization. The amount of oil drawn into the annulus was noted.

To begin collapse experiments oil was injected into the annulus. The pressure was continuously monitored. The normal course of the pressure evolution was such that it increased with increasing injected volume until such a time that the liner buckled. At that point the pressure, depending on the installed tightness of the liner, fell rapidly by a large fraction of the peak pressure (for tight and neutral liners) or dropped slightly and leveled off for loose liners. After the buckling pressure was reached, and exceeded to the degree necessary to ascertain that it was indeed reached, the valve connecting the injection apparatus was closed, and the valve connected to the collection apparatus and graduated cylinders was opened. All the other collection valves were also opened. Any elastic recovery by the liner will push some of the injected oil out of the annulus through the collection system. After the oil was collected and the volume recorded, the collection valves were closed and volumetric cylinders were emptied. The process was repeated for several cycles.

Normally after the fifth collapse, instead of collecting the oil via an elastic recovery of the liner, the pipe bore was re-pressurized to 500 psi. This forcibly ejected the injected oil from the annulus into the collection system. The graduated cylinders were then filled to the upper mark and the internal pressure was reduced to ambient. As the liner relaxed away from the wall, oil was pulled into the annulus through the collection system. The sixth and subsequent collapses were conducted as before.

During the collapse-recovery cycles the annulus volume was indicated by the oil volume in the annulus. The ability of the liner to recover its initial shape and diameter after being collapsed is an indication of the durability of the liner and is herein referred to as collapse tolerance. If the annulus volume after collapse is greater than the theoretical maximum volume calculated from the difference between the ID of the steel and the initial OD of the liner, then the liner is said to have poor collapse tolerance. The theoretical annulus volume of tight and neutral liners is zero. For loose liners it is a nonzero value that increases with the as-installed gap between the liner and the host pipe wall.

The results of these experiments are presented in Table 3. The first column indicates the point at which the volume is recorded.

TABLE 3
Annulus oil volumes during collapse experiments on polyamide 11 liners.

| | Loose Annulus | | | Neutral Annulus | | | Tight Annulus | | |
|---|---|---|---|---|---|---|---|---|---|
| | Volume, ml | | | Volume, ml | | | Volume, ml | | |
| Sequence | 80° C. | 90° C. | 105° C. | 80° C. | 90° C. | 105° C. | 80° C. | 90° C. | 105° C. |
| Start | 582 | 695 | 415 | 0 | 313 | 0 | 0 | −7 | 17 |
| After 1 | 577 | 766 | 560 | 135 | 331 | 430 | 15 | 70 | 82 |
| After2 | 637 | 752 | 635 | 180 | 313 | 370 | 20 | 190 | 92 |
| After3 | 837 | 760 | 690 | 190 | 321 | 260 | 24 | 173 | 117 |
| At 500 psi | 327 | | | | | | | | |
| Before 4 | 707 | | | | | | | | |
| After 4 | 637 | 892 | 680 | 200 | 314 | 420 | 590 | 180 | 149 |
| At 500 psi | 127 | | | | | | 65 | | |
| Before 5 | 507 | | | | | | 65 | | |
| After 5 | 627 | 907 | 400 | 95 | 284 | 355 | 1425 | 157 | 187 |
| At 500 psi | | 152 | −45 | | −96 | −95 | 590 | 4 | 164 |
| Before 6 | | 819 | 495 | | 273 | 220 | 590 | 89 | 452 |
| After 6 | | 869 | | 130 | 310 | 495 | | 197 | 448 |
| After 7 | | 890 | | | | | | | |
| Theoretical | 865 | 834 | 790 | 0 | 0 | 0 | 0 | 0 | 0 |
| Maximum | | | | | | | | | |
| % of | 73 | 107 | 63 | | | | | | |
| Theoretical | | | | | | | | | |
| Maximum | | | | | | | | | |

The following notation is used:

Start is the amount of oil drawn into the annulus upon initial depressurization from 500 psi conditioning.

After 1, After 2, etc. are the annulus oil volumes calculated from the amount residual in the annulus before injection plus the oil volume injected minus the oil expelled as the liner relaxes after collapse.

At 500 psi is the amount of oil left in the annulus after re-pressurization of the pipe to 500 psi.

Before 4, Before 5, etc. is the oil in the annulus after oil is drawn into the annulus when the 500 psi pressure is removed from the pipe and the liner relaxed back away from the steel pipe wall.

Theoretical Maximum is the maximum annular volume calculated from the difference between the ID of the steel pipe, the installed OD of the liner, and the length of the test piece.

Since the theoretical maximum annulus volume for tight and neutral liners is zero, any positive oil volumes associated with the neutral and tight liners at 500 psi and after any injection—recovery cycle indicate the development of a “permanent” annulus volume. These volumes result in a decreased cross sectional area of the lined pipe bore, and an increased annular volume into which high pressure gases can permeate.

At 500 psi, the loose liner at 105° C. and the neutral liner at 90° C. and 105° C. show negative volumes. The only reasonable explanation for these results is cumulative errors in measuring volumes other than the injected volumes, which are very precisely known. There were noted in the experimental record seceral occasions when the oil, collected on liner relaxation and/or pressurization to 500 psi, contained bubbles, presumably due to the oil mixing with trapped gases in the annulus that remained after installation of the liner. This would result in over-measurement of the volume of oil recovered compared to the known amount of bubble-free oil injected, resulting in a negative annulus volume after subtraction.

The tight liner exceeded the theoretical annulus volume in all cases. Upon repressurization to 500 psi after the fifth collapse there is still evidence of a permanent annulus volume. For the tight liner the annulus volume becomes progressively large with subsequent collapses at each of the three temperatures.

For the neutral liner, after 6 collapse cycles the annulus volume is large for each of the temperatures, but essentially unchanged after the first collapse. This indicates the rapid development of a stable annular volume that is within the experimental uncertainty full recoverable over at least several collapse cycles. Visual examination of the liner after the experiments were complete did not reveal anything unusual at any temperatures.

The loose liner volumes do not exceed the theoretical maximum when repressurized to 500 psi. After several collapse cycles the annular volume increases gradually, but is reversible upon re-pressurization to a volume lower than the starting volume. This indicates that the liner is able to recover its pre-collapse cross-sectional area. The liner is also capable of being restored to pre-collapse proximity to the host pipe wall. None of the loose polyamide-11 liners sustained any permanent deformation that could be observed on removal after completion of the testing.

The resistance to permanent deformation is evidence of collapse tolerance. The loose liner displays this characteristic. The neutral liner can also recover its original cross sectional area and is considered collapse tolerant. The tight liner is not collapse tolerant. A permanent annular volume develops on the first collapse and it grows with subsequent collapses. It cannot be recovered by re-pressurizing the liner.

Similar experiments were conducted using HDPE liners. The temperatures for the HDPE experiments were different to reflect the normal upper use temperature range for HDPE liners. There are two loose liner cases. The 5% loose liner reflects common HDPE loose liner industry practice. The 2.5% loose liner has approximately the same degree of looseness as the polyamide-11 loose liner. The tight liner is slightly tight, reflecting common industry practice based on field experience. Table 4 shows the annulus oil volume results over several collapse cycles.

TABLE 4
Annulus oil volumes during collapse experiments on HDPE liners

| | 5% Loose | | 2.5% Loose | | Tight | |
|---|---|---|---|---|---|---|
| | Annulus | | Annulus | | Annulus | |
| | Volume, ml | | Volume, ml | | Volume, ml | |
| Sequence | 40° C. | 60° C. | 40° C. | 60° C. | 4° C. | 60° C. |
| Start | 700 | 252 | 47 | 5 | 27 | 5 |
| After 1 | 940 | 465 | 221 | 493 | 126 | 86 |
| After 2 | 885 | 432 | 276 | 518 | 247 | 124 |
| After 3 | 946 | 417 | 309 | 558 | 435 | 72 |
| After 4 | 925 | 390 | 271 | 588 | 382 | 126 |
| After 5 | 937 | 330 | 194 | 243 | 181 | 187 |
| At 500 psi | 133 | −120 | −69 | −8 | −236 | 150 |
| Before 6 | 574 | 291 | 125 | −6 | 25 | −3 |
| After 6 | 775 | 392 | 214 | −66 | 1418 | 509 |
| Theoretical | 1637 | 1637 | 719 | 703 | 0 | 0 |
| Maximum | | | | | | |
| % of | 47 | 24 | 30 | | | |
| Theoretical | | | | | | |
| Maximum | | | | | | |

The conventional thought about the behavior of HDPE liners is summarized in a publication of the National Association of Corrosion Engineers International (NACE Publication 1G190, Item No. 54269, page 7) which says “The liner . . . becomes mechanically locked into position by compression set and stress relaxation over time.”, and “The liner may require from 1 day to 1 year to mechanically lock into the ID of the steel pipe as a results of surface roughness of the steel. This normally occurs, however, within about six weeks.”. Based on this experience of the industry we expected that the six weeks of conditioning at 500 psi was sufficient to accomplish the noted stress relaxation. If the stress relaxation had occurred as noted in the NACE publication, the starting volumes would have been very close to zero as is the case for the 60° C. liners at 2.5% loose and tight fit. Since the conditioning for these experiments was almost exactly six weeks, it is possible that, at least for the 5 percent loose case, not enough time had passes for the stress to fully relax leaving the HDPE liner in full, inelastic contact with the steel pipe wall.

Visual examination of the HDPE liner after completion of the collapse tests revealed damage to the liners that increased in severity with temperature and tightness.

The mechanical properties of HDPE are known to deteriorate over time on exposure to hydrocarbon liquids at elevated temperatures. The test results in Table 5 show the time dependence at the two test temperatures of this study using specimens from HDPE pipe intended for use as a liner. It is clear that at 40° C. the stiffness properties (Young's Modulus) are still declining, but at 60° C. the properties appear to have become stable. Exposures were made at the indicated temperature, measurements were made at room temperature as per ASTM D-638. The decrease in Young's Modulus results in a decrease in the force with which the liner can attempt to recover its initial shape and eject the annular fluid. This decreased ability is still evolving at 40° C. after 32 weeks. At 60° C. equilibrium appears to have been established at 16 weeks. This is more than the 6 weeks of conditioning in the collapse tests so we cannot say conclusively that at 6 weeks the 60° C. liner has reached equilibrium.

The implications for the liner performance is clear: At 60° C. the HDPE liner in a loose configuration retains at best a small fraction of the theoretical maximum annulus volume. At 40° C. the recoverable annulus volume is small compared to the theoretical volume and is declining. And in the tight configuration a permanent annulus with the attendant cross-section al area reduction is well developed.

TABLE 5
Evolution of the tensile properties of HDPE with hydrocarbon exposure

| | | Exposed at 40° C. | | Exposed at 60° C. | |
|---|---|---|---|---|---|
| | New | 16 Weeks | 32 Weeks | 16 Weeks | 32 Weeks |
| Young's | 394 | 193 | 181 | 162 | 162 |
| Modulus, MPa | | | | | |
| Yield Stress, MPa | 21.3 | 17.7 | 17.9 | 17.1 | 17.1 |
| Yield Elongation, | 19.7 | 36 | 37.3 | 46.2 | 48.1 |
| % | | | | | |

The long-term properties of polyamide-11 have been verified by field experience in service as severe as the environment of these tests. After three years of exposure at 65° in crude gas service a polyamide-11 liner was tested in the laboratory for mechanical properties. The results are presented in Table 6. The service conditions are presented in Table 7. The data indicate that polyamide-11 does not become less stiff with long-term exposure to severe hydrocarbon environments. Based on these results we can assume that the polyamide-11 liners used for the collapse study will not loose properties over time in the petroleum environment.

TABLE 6
Tensile properties of polyamide-11 liner after 3 years
uz,11/22 service in sour, crude gas.

| | Young's Modulus, | Yield Stress, | Yield Elongation, |
|---|---|---|---|
| | MPa | MPa | % |
| New liner | 278 | 27 | 32 |
| Exposed liner | 283 | 28 | 43 |

TABLE 7
Chemical environment for polyamide-11 exposure study.

| Chemical Species | Mole Percent |
|---|---|
| Hydrogen sulfide | 17.5 |
| Carbon dioxide | 1.9 |
| Methane | 62.3 |
| C₂-C₇ hydrocarbon | 18.3 |
| condensates | |

### SUMMARY

Tight liners of both HDPE and polyamide-11 sustain permanent damage when subjected to collapse conditions.

Plasticized polyamide-11 liners, when inserted to have a smaller OD than the ID of the host pipe, after long periods of hydrocarbon exposure

1. do not sustain permanent deformation after numerous collapse cycles.

2. are able to elastically relax away from the host pipe wall when the pressure differential is removed.

3. can be fully restored to pre-collapse shape and dimensions when internal pressure is reapplied.

4. are tolerant of catastrophic collapse conditions that cause damage to conventional materials installed in a similar geometry.

The elastic recovery tendencies of loose polyamide-11 liner makes a large annular volume available for expanding permeated gases when the pipeline bore is depressurized, resulting in decompression of the small volume of annular high pressure gases.

The availability of a large annular volume (compared to the microannular volume during operation, makes it possible to design a polyamide-11 liner that is essentially collapse-proof.

The subject matter which applicant regards as his invention is particularly pointed out and distinctly claimed as follows:

I claim:

1. An improved thermoplastic polymer lined metal pipeline for the transport of petroleum products wherein the improvement comprises a thermoplastic liner in said lined pipeline having a loose fit and consisting essentially of polyamide 11 or polyamide 12 and having the ability to retract from the pipeline when some of the petroleum product diffuses through the liner and to recover completely from multiple retractions and transient collapses, thus permitting the space between the metal pipeline and the thermoplastic liner to be unvented for extended periods of time beyond what is normally done for conventional thermoplastic liners.

2. An improved thermoplastic polymer lined metal pipeline as defined in claim 1 wherein the thermoplastic liner consists essentially of polyamide 11.

3. An improved thermoplastic polymer lined metal pipeline as defined in claim 1 wherein the thermoplastic liner consists essentially of polyamide 12.

4. An improved process for lining a metal pipeline with a thermoplastic liner, said lines having the ability to recover from multiple transient collapses and wherein said ability to recover from multiple transient collapses is desired, wherein the improvement comprises inserting a thermoplastic liner consisting essentially of polyamide 11 or polyamide 12 in said metal pipeline in a loose fit configuration.

5. An improved process as defined in claim 4 wherein the thermoplastic liner consists essentially of polyamide 11.

6. An improved process as defined in claim 4 wherein the thermoplastic liner consists essentially of polyamide 12.
